(19) United States
(12) Patent Application Publication
(10) Pub. No.: US 2015/0340799 A1
(43) Pub. Date: Nov. 26, 2015

(54) CONNECTOR FOR CONNECTING MOTOR VEHICLE WIRING HARNESSES TO TERMINALS THROUGH A FLANGE

(71) Applicant: Robert Bosch Limitada, Campinas (BR)

(72) Inventors: Allan Francisco Oliveira, Indaiatuba - SP (BR); Alexandre Denadai Rugero, Americana - SP (BR)

(21) Appl. No.: 14/759,087

(22) PCT Filed: Dec. 27, 2013
(86) PCT No.: PCT/BR2013/000606

§ 371 Date: Jul. 27, 2015

(30) Foreign Application Priority Data
Jan. 2, 2013 (BR) 10 2013 000076-0

(51) Int. Cl. H01R 13/52; H01R 4/18; H01R 4/02

(52) U.S. Cl. CPC H01R 13/5202; H01R 4/02; H01R 4/18

(57) ABSTRACT

A connector for connecting electric wire harnesses to electric terminals through flanges of fuel tanks of automotive vehicles. The connector includes a free electric terminal to provide interface with the electric device of the vehicle, an electric cable for connection with the device inside the flange, and a metallic pin that establishes electric contact between the electric terminal and the electric cable. The connector provides a universal fixation for terminals and cables to the outer and inner walls of the flange, the connector further providing sealing on the passage of the electric wire harness through the flange and having conductive properties similar to those of an infinite bus.

### BACKGROUND OF THE INVENTION

The present invention relates to an electric wire harness connection with terminal through flange, the connector comprising a terminal, a metallic pin, an electric cable and a sealing ring. The connector has a plurality of male-fixation elements arranged radially to the pin, a canal in the pin for positioning the sealing ring, a bore at the lower end of the pin for fixing the electric cable and a terminal fixed to the upper end of the pin. In one embodiment of the invention, the terminal may be eliminated, wherein the pin end may be manufactured with a shape equivalent to the terminal.

Modern vehicles have a diversity of cable groupings, usually called harness, which has the function of interconnecting a growing number of electric components, for instance, sensors, actuators, fuel pumps, and injector nozzles. These harnesses need fixing and connecting devices for passing through the physical space between the components to which they will be connected.

The development of flanges for fuel tanks, which, among other functions, is responsible for conducting the electric current between the components of the fuel module and the electric harness of the client, besides restricting the escape of fuel vapors inherent to the fuel, is a development that is subject to characteristic challenges. These challenges typically embrace the risk of poor sealing, the risk of overheating of the elements due to the electric resistance generated by poor contact, the problem of optimizing the internal space used, the planning of the element to facilitate mounting and repair, decrease in time and cost of manufacturing the connectors, and further the possibility of wide application on various models of automotive vehicles without the need for further modifications.

Prior-art document U.S. Pat. No. 5,631,445A reports the arrangement of a plug that has the purpose of conducting electric current between the components of the fuel module through the flange and the electric harness and further sealing off the vapors inherent in the fuel transported. In the case of the device set forth, the cables are fixed to the plug by over-injection of plastic material. The plug is mounted on the flange through a bore that passes through it, wherein a sealing element, in this case an “O”-ring, is mounted between the flange and the plug to seal this interface, thus preventing the passage of fuel and fuel vapors to the environment out of the tank. In this document, the plug does not have any cuts or cable joint. This configuration does not provide flexibility in relation to the different type of equipment to be connected inside and outside of the fuel tank.

In document WO9910206A one presents flanges molded over vehicle electric cables having less specific applications than the matter of document U.S. Pat. No. 5,631,445A, since the latter seeks to solve problems inherent in sealing of fuel tanks In both documents the molding of flanges and connectors over the cables plays the role of reducing the number of electric contacts along the harness, but this configuration brings restrictions when one desires to achieve a solution that applies to a larger number of commercial vehicles. However, long harnesses with over-molded flanges and connectors have their use limited to their manufacture length.

In order to provide less restriction of applicability on commercial vehicles, prior-art document JP9264226A presents a fuel flute having connectors that enable connection with a wide range of injector nozzles. This effect is achieved when an intermediate connection is provided between the harness and the terminal of the injector nozzle. The electric harness is connected to a supply terminal inside the flute, which in turn is connected to a connection terminal belonging to the injector nozzle. There are two terminals inside the flute and two through-bores for entrance of the harness and of the connection terminal, respectively, which causes the object to exhibit robustness problems and great complexity. The two contact points of the terminals provide voltage and frequency variations in the electric current, increasing the chances of failure due to overheating.

In document JP11167960A, one presents an electric connector for fuel tank, characterized by low manufacture cost and economy of internal space used in connecting it. In this document, one describes how to provide connection between the electric cable and the terminal by molding resin over the terminal. In spite of the low cost of the solution, it consists of a complex process that needs adjustment of the element 36 inside the compartment 32, besides having to mount the assembly on the flange 11 by interference.

### SUMMARY OF THE INVENTION

The present invention has managed to achieve an optimum balance between the reduction of connections and universality of application on commercial vehicles. The proposal of the present invention is to arrange a connector with a single contact element between the electric cable, which is connected to the fuel pump, and the terminal, which is positioned outside the fuel tank and is connected to the electric harness of the vehicle, the only contact element being the metallic pin.

According to the present invention, there are only two electric connection points between the electric cable of the components of the fuel module and the terminal that establishes connection with electric harness of the vehicle. In a second embodiment, there is only one point of electric connection.

The connector that constitutes the novel development proposed herein is a part that is easy to mount and dismount on as many commercial vehicles as possible, aiming at the universality of application thereof. This is the development of a universal connection for electric harnesses and terminals of vehicles, having excellent conductive properties and adequate sealing.

The objective of the present invention is to provide a connector for electric wire harness comprising: a machined metallic pin, an electric cable, a sealing ring and a free electric terminal, wherein the latter, in a second embodiment of the invention, may be machined at the end of the metallic pin in the form of a terminal. The connector may exhibit an overinjection of plastic material over the metallic pin and the joining with the cable, to facilitate the mounting and fixation thereof onto the flange.

The main function of this connector is to connect electric devices separated by a wall. It is also a function of this connector to fix the electric cable and the electric terminal to the wall, while promoting sealing of the passage bore, preventing fluids from flowing through the wall, said fluids being liquids, vapors or gases.

The machined pin body has a canal for housing a sealing ring. The electric cable is fixed in a lower part of the metallic pin.

In order to fix the electric cable, a possible process is crimping it into a bore in the metallic pin. Another possibility to fix the electric cable to the metallic pin is by welding.

At an upper part of the metallic pin there is the free electric terminal, which may be a metallic element welded to the metallic pin or still an extension of the metallic pin itself, obtained by machining

The wall section through which the connector passes has flaps with a plurality of female fixing elements, and these flaps may be an extension of the wall itself, forming a flange or may belong to a flange complementary connector, the latter form being usual on commercial vehicles. The connector has male fixing elements exhibiting complementary shape with respect to the female fixing elements of the flange, in a number identical to the plurality of female fixing elements, so that the set of male and female fixing elements forms a snap closure. The male fixing elements may be machined on the metallic pin body or achieved by over-molding plastic material to the metallic pin.

Summarizing, the present invention concomitantly solves the prior-art problems of sealing on cable passages and of universality of harness connections for application on automobiles on its free electric terminal, in particular harness connections on fuel tanks The object of the present invention further exhibits simplified mounting process, without requiring complementary steps after manufacture, while mounting or repairing the harness. It is also an essential characteristic of the invention that the connector is a machined metallic element of robust geometry, with electric conductivity properties similar to those of an infinite bus.

### BRIEF DESCRIPTION OF THE DRAWINGS

The present invention will now be described in greater detail with reference to embodiment examples represented in the drawings. The figures show:

FIG. 1—a cross-sectional schematic view representing an embodiment example of the connection, object of the present invention, wherein the connection is arranged through a flange;

FIG. 2—a front view of a second embodiment of the connection, object of the present invention.

### DETAILED DESCRIPTION

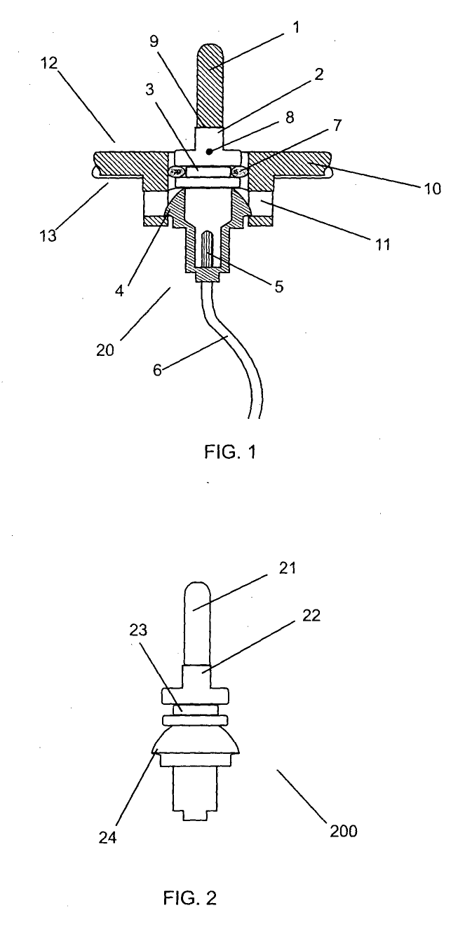

In FIG. 1, a first embodiment of the connector 20 of the invention is represented with the main elements standing out. The connector 20 performs the function of providing electric contact between an electric terminal 1 and a cable 6. Is it also one of the essential functions of the present invention to fix the electric terminal 1 and the cable 6 to the external and inner walls 12, 13 of a flange 10.

The electric terminal 1 is a metallic element arranged substantially in vertical direction and that serves as a free interface for connection with a device, usually a power source and/or command unit, not shown in the figure. This is a free electric terminal for connection of any electric devices. In the first embodiment represented in FIG. 1, the electric terminal 1 is joined to a metallic pin 2 by a welding process. The metallic pin 2 is a metallic part obtained by machining an essentially cylindrical material.

The union between the metallic pin 2 and the electric terminal 1 is made by welding in this first embodiment. A welding point is made in a bore 8 to fix the electric terminal 1 inserted into the opening 9 of the metallic pin 2. One may also weld a plane face machined on the metallic 2 onto the lower plane face of the electric terminal 1.

The metallic pin 2 has a sealing ring 7 positioned on the canal 3 for sealing ring. This ring 7, which is usually made of an elastomer resistant to chemical fumes, accounts for the sealing between the environment in contact with the inner wall 13 of the flange 10 and the environment in contact with the outer wall 12 of the flange 10. This sealing is necessary for typical applications on vehicles, where the environment on contact with the inner wall 13 contains fumes inherent to the fuel.

A plurality of male fixing elements 4 are arranged in radial direction with respect to the metallic pin 2, which, in conjunction with female fixing elements 11 belonging to the flange 10, form a snap closure, preventing relative movement between the connector 20 and the flange 10. In FIG. 1, the male fixing elements are plastic elements over-molded to the lower portion of the metallic pin 2. However, other mechanical fixing forms are also possible.

The cable 6 is fixed to the lower portion of the metallic pin 2. The fixation of the cable 6 to the metallic pin 2 may be made in a number of ways. A possible solution is by crimping, where the part that leads the cable 6 is inserted into a bore 5 at the lower part of the pin 2. By mechanical deformation of the region surrounding the bore 5, the cable 6 is fixed to the metallic pin 2. Another way to fix the cable 6 to the metallic pin 2 is by welding.

The over-injection of plastic material, made at the lower part of the metallic pin 2 is optional, since fixing elements 4 may be used or stamped directly from the body of the metallic pin 2. If there is an over-injection of plastic at the lower part of the metallic pin 2, the latter, besides forming the fixing elements 4, can also cover the joining area between the cable 6 and the metallic pin 2. This plastic covering of the area of electric connection between the cable 6 and the metallic pin 2 aids in the protection thereof against possible corrosion by chemical fumes within the fuel tank.

FIG. 2 is a front view of the second embodiment of the connector 200. In this embodiment, the terminal 21 consists of an upper extension of the metallic pin 22, the two elements forming a single machined metallic part. The terminal 21 is a portion of the metallic pin 22, which extends substantially in vertical direction and serves as an interface for connection with the vehicle device, usually a power feed and/or a command unit, not shown in the figure.

In order to fix the metallic pin 22 to the flange 10, there is a plurality of male fixing elements 24 in radial direction with respect to the metallic pin 22. The male fixing elements 24, in conjunction with female fixing elements 11 belonging to the flange 10, form a snap closure preventing relative movement between the connector 200 and the flange 10. In FIG. 2, the male fixing elements 24 are elements formed by machining or another mechanical manufacturing process of a portion of the metallic pin 22, which extends in substantially radial direction with respect to the connector 200.

The connector 20, 200 of the present invention presents, as clear advantages with respect to the prior art, the following points:

1. Decrease electric connection points, with reduction of mounting processes and decrease in the space occupied below the flange for electric connections.

2. Elimination of dismountable electric connection points. The electric connections are made by processes that do not foresee dismounting, as for example, insertion and/or welding. This enables more robust, rigid electric connection, without potential clearances between the connected components, thus eliminating failures due to increase in contact resistance, with the consequent rise in temperature and possible burning of the electric contact.

3. Simplification of the flange by eliminating the need for a terminal over injected on the flange. The process of over-injecting the terminal on the flange needs an operator dedicated to mounting the terminals on a device, which will then be inserted into the flange injection mold, or an automated system that performs this function. According to the present invention, the flange will have only through-bores, where the proposed connectors will be mounted.

4. Potential reduction of the cost as a function of what was set forth in items 1 and 3 above.

A preferred example of embodiment having been described, one should understand that the scope of the present invention embraces other possible variations, being limited only by the contents of the accompanying claims, which include the possible equivalents.

### REFERENCE NUMBERS

1, 21—electric terminal

2, 22—metallic pin

3, 23—sealing ring canal

4, 24—male fixing element

5—lower bore

6—electric cable

7—sealing ring

8—bore for welding point

9—upper opening

10—flange

11—female fixing element

20, 200—connector

1. A connector for connecting an electric wire harness to terminals through a flange, the connector comprising a free electric terminal, a metallic pin an electric cable and a sealing ring, the connector having a plurality of male fixing elements arranged radially with respect to the connector, wherein the free electric terminal is directed to the outside of the flange.

2. The connector according to claim 1, wherein the metallic pin is joined to the electric terminal by welding.

3. The connector according to claim 1, wherein the electric terminal is integral with the metallic pin.

4. The connector according to claim 1, wherein the male fixing elements are part of a plastic over-injection on the metallic pin.

5. The connector according to claim 4, wherein the plastic over-injection covers a lower part of the metallic pin, including a union of the cable with the metallic pin.

6. The connector according to claim 1, wherein the male fixing elements are an extension of the metallic pin.

7. The connector according to claim 1, wherein the cable is fixed to the metallic pin by crimping or welding.

8. The connector according to claim 1, wherein the sealing ring is an “O”-ring of elastomer.

9. The connector according to claim 2, wherein the male fixing elements are part of a plastic over-injection on the metallic pin.

10. The connector according to claim 9, wherein the plastic over-injection covers a lower part of the metallic pin, including a union of the cable with the metallic pin.

11. The connector according to claim 1, wherein the flange is a flange of an automotive vehicle.

12. The connector according to claim 11, wherein the flange is a flange of a fuel tank.

13. The connector according to claim 3, wherein the male fixing elements are an extension of the metallic pin.
